(19) United States
(12) Patent Application Publication
(10) Pub. No.: US 2012/0179704 A1
(43) Pub. Date: Jul. 12, 2012

(54) TEXTUAL QUERY BASED MULTIMEDIA RETRIEVAL SYSTEM

(75) Inventors: Dong Xu, Singapore (SG); Wai Hung Tsang, Singapore (SG); Yiming Liu, Singapore (SG)

(73) Assignee: Nanyang Technological University, Singapore (SG)

(21) Appl. No.: 13/496,447

(22) PCT Filed: Sep. 16, 2010
(86) PCT No.: PCT/SG10/00343

§ 371 Date: Mar. 15, 2012

Related U.S. Application Data
(60) Provisional application No. 61/242,975, filed on Sep. 16, 2009.

(51) Int. Cl. G06F 17/30

(52) U.S. Cl. 707/766; 707/E17.075

(57) ABSTRACT

A system and method are proposed for identifying multimedia files in a first database which are related to a textual term specified by a user. The textual term is used to search a second database of multimedia files, each of which is associated with a portion of text. The “second database” is usually composed of files from the databases of a very large number of servers connected via the internet. The multimedia files identified in the search are ones for which the corresponding associated text is relevant to the textual term. The identified multimedia files are used to generate a classifier engine. The classifier engine is then applied to the first database of multimedia files, thereby retrieving multimedia files in the first database which are relevant to the textual term. The user can optionally specify whether the retrieved multimedia files are relevant or not, and this permits a feedback process to improve the classifier engine.

### FIELD OF THE INVENTION

The present invention relates to methods and apparatus for searching a first database of multimedia files based on at least one textual term (word) specified by a user.

### BACKGROUND OF THE INVENTION

With the rapid popularization of digital cameras and mobile phone cameras, retrieving selected images from enormous collections of personal photos or videos has become an important research topic and practical problem. In recent decades, many Content Based Image Retrieval (CBIR) systems [18, 20, 21, 34] have been proposed. These systems usually require a user to provide images as queries to retrieve personal photos or videos. This is the so-called “query-by-example” framework, which identifies items in the database which resemble the example items provided by the users. The paramount challenge in CBIR is the so-called semantic gap between low-level visual features (which tend to be relatively simple to identify computationally) and high-level semantic concepts. To bridge the semantic gap, relevance feedback methods have been proposed to learn the user's intentions.

For consumer applications, it is more natural for the user to retrieve the desirable personal photos using textual queries. For example, users commonly search the internet for relevant images using the Google image search service. However, a Google image search cannot be directly used to perform a textual query within a user's own photo collection, e.g. generated by the user's digital camera. This is because a Google image search can only retrieve web images which are identifiable by rich semantic textual descriptions (such as their filename, or the surrounding texts, or URL). Raw target photos from digital cameras do not contain such semantic textual descriptions.

In order to make textual searching of a photo database easier, image annotation is commonly used to classify images with respect to high-level semantic concepts. This result can be used for textual query based image retrieval because the semantic concepts are analogous to the textual terms describing document contents. In general, the image annotation methods can be classified into two categories: learning-based methods and web-based methods [14]. Learning-based methods build robust classifiers based on a fixed corpus of labeled training data, and then use the learned classifiers to detect the presence of the predefined concepts in the test data. Recently, Chang et al. [3] proposed a system for consumer video annotation. Their system can automatically detect 25 predefined semantic concepts, including occasions, scenes, objects, activities and sounds. Observing that the personal photos are usually organized into collections by time, location and events, Cao et al. [1] proposed a label propagation method to propagate concept labels from certain personal images in a given album to the other photos in the same album.

By contrast, web-based methods, are an emerging paradigm. These methods leverage millions of web images and the associated rich textual descriptions for image annotation. Zhang et al have proposed a series of works [16, 25, 26, 28, 29] to utilize images and associated high quality descriptions (such as surrounding title and category) in photo forums to annotate general images. On a given query image, their system first searches for similar images among those downloaded images from the photo forums, and then mines representative and common descriptions (concepts) from the surrounding descriptions of these similar images as the annotation for the query image. The initial system [28] requires the user to provide at least one accurate keyword to speed up the search efficiency. Subsequently, an approximate yet efficient indexing technique was proposed, such that the user no longer needs to provide keywords [16]. An annotation refinement algorithm and a distance metric learning method were also proposed to further improve the image annotation.

Torralba et al. [22] collected about 80 million tiny images (color images with the size of 32 by 32 pixels), each one of which is labeled with one noun from a lexicon called WordNet (which is described in more detail below). They demonstrated that with sufficient samples, a simple kNN classifier can achieve reasonable performance for several tasks such as image annotation, scene recognition, and person detection and localization. Subsequently, Torralba et al. [23] and Weiss et al. [30] also developed two indexing methods to speed up the image search process by representing each image with less than a few hundred bits.

In [14], Jia et al. proposed a web-based annotation method to obtain conceptual labels only for clusters of images within a photo album, followed by a graph-based semi-supervised learning method to propagate the conceptual labels to the rest of the photo album. To obtain the initial annotations, the users are required to describe each photo album using textual terms, which are then submitted to a web image server (such as Flickr.com) to search for thousands of images related by the keywords. Therefore, the annotation performance depends heavily on the textual terms provided by the users, and the search quality of the web image server.

Although it is possible to perform textual queries of image databases by first annotating the images using one of the above techniques, the image annotation process would need to be performed whenever new textual terms are chosen. The technique is therefore computationally-intensive and cannot be performed in real time.

### SUMMARY OF THE INVENTION

The present invention aims to provide new and useful methods and systems for retrieving multimedia files from a first database of such files, based on at least one textual term (a word) specified by a user.

In general terms, the invention proposes that, after the user specifies at least one textual term, it is used to search a second database of multimedia files, each of which is associated with a portion of text. The “second database” is usually obtained from databases of a very large plurality of servers connected via the internet (the whole set of files accessible over the internet can also be considered a database). The multimedia files identified in the search are ones for which the corresponding text is relevant to the textual term, for example in the sense of including the textual term, or possibly also in the sense of including a synonym thereof. The identified multimedia files are used to generate a first multimedia file classifier engine. The first multimedia file classifier engine is then applied to the first database of multimedia files, thereby identifying (“retrieving”) multimedia files in the first database which are relevant to the textual term.

Note that preferred embodiments of the invention do not require the user to perform any annotation of his or her personal multimedia items. Furthermore, since, unlike some of the known methods described, they do not involve a process of annotating all the multimedia files of the first database, certain embodiments of the invention can be implemented in real time. The invention is motivated by the advances in Web 2.0 and the recent advances of web-based image annotation techniques [14, 16, 22, 23, 25, 26, 28, 29]. Everyday, rich and massive social media data (texts, images, audios, videos, etc.) are posted to the web. Web images are generally accompanied by rich contextual information, such as tags, categories, titles, and comments.

The term “multimedia file” is used to mean any file containing any of graphics, animation, images or video. It may be any file other than a text file. However, preferably each multimedia file includes or consists of one or more images and/or items of video. In one example, each multimedia file is a respective image file. In the rest of the patent, we take images as an example, but embodiments of the invention can be readily used for other types of multimedia files such as graphics, animation or videos. For example, a video sequence can be represented as one image (i.e., one key-frame) such that embodiments of the invention can be directly employed.

Preferably, the first multimedia file classification engine is able to generate relevance scores, each indicating the relevance of the textual term to a corresponding multimedia file in the first database, and thereby rank the multimedia files in the first database according to the relevance score. This is not possible in many of the known techniques described above.

In some embodiments of the invention, the process of searching the second database for multimedia files relevant to the textual term further includes identifying multimedia files in the second database which are not relevant to the textual term, and both sets of multimedia files are used in deriving the first multimedia file classifier engine. Whether the irrelevant multimedia files are useful for this depends on which type of classifier is used as the first multimedia file classifier engine.

In many applications of the invention, there will be far more irrelevant multimedia files in the second database than relevant multimedia files. In this case, embodiments may select (e.g. randomly) one or more sets of the irrelevant multimedia files (each set of irrelevant multimedia files being about the same, or comparable, in number to the relevant multimedia files from the second database), and generate the first multimedia file classifier using the one or more sets of irrelevant multimedia files. The embodiment may, for each of the sets of irrelevant multimedia files in the second database, construct a corresponding non-linear function using that set of irrelevant multimedia files and also the relevant multimedia files, and then generate the first multimedia file classifier as a sum (e.g. a weighted sum) of the non-linear functions.

In one form, the system performing the method of the invention includes a feature extraction module (e.g. a sub-routine) for obtaining, for a given input multimedia file, numerical feature values indicating the corresponding degrees to which the input multimedia file includes each of a plurality of corresponding predetermined multimedia file features.

The first multimedia classifier engine may comprise a sum over the multimedia file features of at least one respective non-linear function of the feature value. There may be one such non-linear function for every set of irrelevant multimedia files and every multimedia file feature. Alternatively, some of these non-linear functions may be discarded from the first multimedia classifier, so that there is only one such non-linear function for each of a plurality (but not all) of the sets of irrelevant multimedia files and/or each of a plurality (but not all) of the multimedia file features.

Alternatively, the first multimedia classifier engine may comprise, for each of one or more of the sets of irrelevant multimedia files, a linear or non-linear function of a product of a weight vector composed of weights, and a vector representing the input multimedia file. This vector may be formed by applying the input multimedia file to the feature extraction module. The weight vector is generated using the relevant multimedia files and the corresponding set of irrelevant multimedia files. The embodiment may generate the first multimedia classifier engine as a sum (e.g. a weighted sum) of the non-linear functions for a plurality of the corresponding sets of irrelevant multimedia files.

The quality of the first multimedia file classifier engine is optionally improved using multimedia files which are explicitly labeled by the user as being relevant or irrelevant to the search terms. Conveniently this is done in a feedback process, by using the method explained above to identify multimedia files of the first database which are believed to be relevant to the textual term, and then the user supplying relevance data indicating whether this is actually correct, e.g. by labeling the multimedia files which are, or are not, in fact relevant to the textual term. The relevance data is used to improve the classification engine, a process known here as “relevance feedback”, and the multimedia files labeled by the user are termed “feedback files”.

One option would be to perform relevance feedback using a large number of web images and a limited amount of feedback files, generating a completely new classifier from the whole set of images. However, classifiers trained from both the web images and feedback files may perform poorly because the feature distributions from these two domains can be drastically different.

We here propose several methods to address this problem. Our first proposed method is that the first multimedia file classifier engine is modified by training an adaptive system using the relevance data and the feedback files. A modified multimedia file classifier engine (“modified classifier engine”) is then constructed as a system which generates an output, when it operates on a certain multimedia file, by submitting that multimedia file to the first multimedia file classifier engine, and to the adaptive system, and combining their respective outputs. Because the adaptive system is trained only on a comparatively small amount of data, the training process can be fast-enough to be performed in real time.

Our second proposed method is to generate a set of weight values defining the modified classifier engine, by performing regression based on a cost function. The cost function typically includes (i) a regularizer term, (ii) a term indicating disparity between the results of the modified classifier engine and the relevance data in respect of the feedback files, and (iii) a term indicating disparity between the outputs of the modified classifier engine and the output of the first file classifier engine when respectively operating on multimedia files in the first database which were not included in the feedback files.

In a preferred form of this option, the terms of the cost function are such that the weight values can be expressed in closed form, as a function of a set of data structures (vectors and/or matrices). Optionally, these data structures are updated each time new relevance data is obtained, e.g. using only the images described by the relevance data, and a new set of weight values are then calculated.

The invention can be expressed as a computer-implemented method. Alternatively, it can be expressed as a programmed computer arranged to implement the steps of the method, for example a computer system including a processor and a memory device storing program instructions which, when implemented by the processor, cause the processor to perform the method. Alternatively, the invention may be expressed as a computer program encoded in a recording medium, which may be tangible recording medium (e.g. a optical storage device (e.g. CD) or a magnetic storage device (e.g. a diskette, or the storage device of a server)) or an electronic signal (e.g. a signal transmitted over the internet), and including program instructions which, when implemented by the processor, cause the processor to perform the method. The tangible recording medium or electronic signal may be a computer program product for retail to users, either separately or bundled with another related commercial product, such as a camera. In fact, the recording medium may be a memory device of a camera. Alternatively, the program may be stored on a server remote from the users but accessible to users (e.g. over the internet) and which performs the steps of the method, after users have first uploaded their images or videos, and transmits data indicating the results of the methods to the users' computers. Optionally, the server transmits advertising material to the users.

### BRIEF DESCRIPTION OF THE EMBODIMENTS

Embodiments of the invention will not be described, purely for the sake of example, with reference to the following drawings, in which:

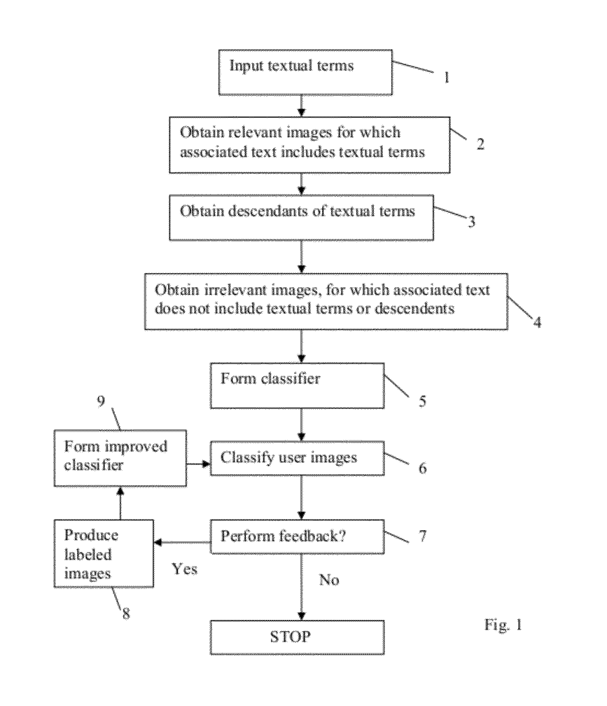

FIG. 1 is a flow diagram showing the steps of a method which is an embodiment of the invention;

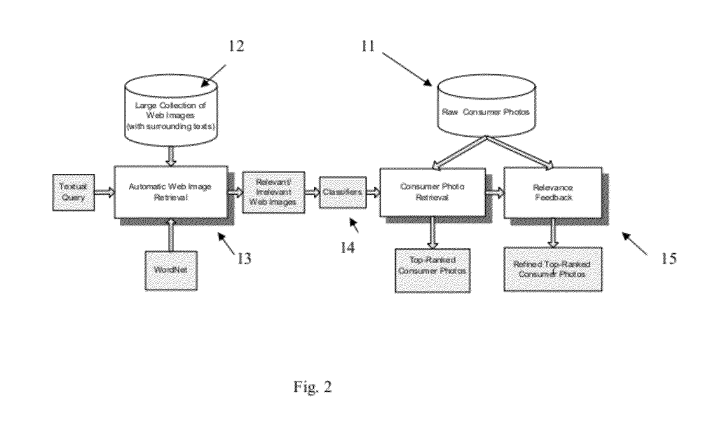

FIG. 2 is a diagram showing the structure of a system which performs the method of FIG. 1;

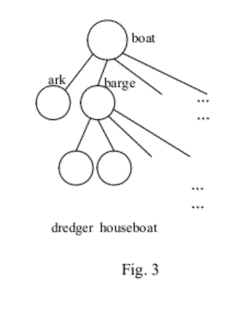

FIG. 3 illustrates how the WordNet database forms associations between textual terms;

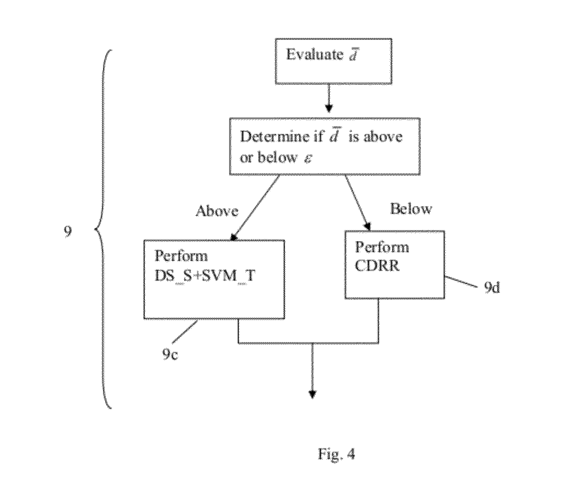

FIG. 4 shows the sub-steps of a first possible implementation of one of the steps of the method of FIG. 1;

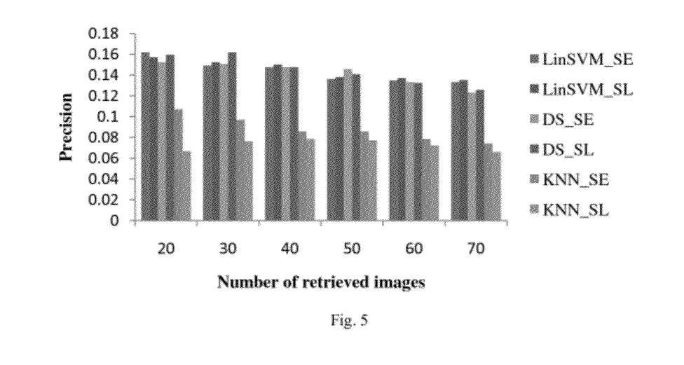

FIG. 5 is numerical data obtained using the method of FIG. 1, illustrating for each of six forms of classifier engine, the retrieval precision which was obtained, measured for the top 20, top 30, top 40, top 50, top 60 and top 70 images;

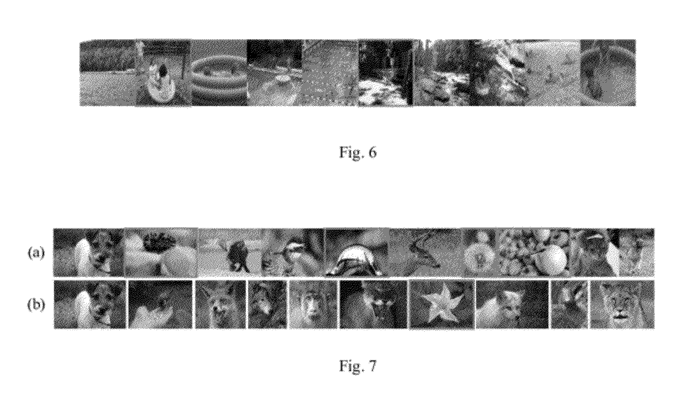

FIG. 6 illustrates the top-10 initial retrieval results for a query using the term “water” on the Kodak dataset; and

FIG. 7 is composed of FIG. 7(a) which illustrates the top 10 initial results from an employment of the embodiment using the search term “animal” on the NUS-WIDE dataset, and FIG. 7(b) which illustrates the results after one round of relevance feedback.

### DETAILED DESCRIPTION OF THE EMBODIMENTS

### 1. Explanation of the Embodiment

FIG. 1 shows the steps of an embodiment of the invention to facilitate textual query based retrieval of images in a user's personal collection. Such personal photos (called here “target photos” or “consumer photos”) are usually organized in folders without any indexing to facilitate textual queries.

FIG. 1 illustrates the steps of a method which is an embodiment of the invention. FIG. 2 illustrates the architecture of a system which performs the method, and shows the flow of information when the method is performed. The system includes a first database 11 which is a collection of the user's personal photographs, and a second database 12 which is a large collection of images with surrounding texts. The content of the database 12 can be obtained from Photosig.com, which is a database described in more detail below, and made up of images originally obtained from the internet, so they are termed “web images”. The number of items is so large that almost all daily real-life semantic concepts are represented. We represent these concepts as C_{w}.

The database 12 is organized so as to make an image search possible using an “inverted file method” [31]. First, stop-word removal is used to remove from C_{w} high-frequency words that are not meaningful. C_{w} is still very large, and we assume that the set of all concepts Cₚ characterizing a user's personal collection of images is a subset of C_{w}. In other words, almost all the possible concepts in a personal collection can be expected to be present in the web image database 12. Then, we organize the database 12 as an inverted file, such that it has an entry for each word q in C_{w}, followed by a list of all the images in database 12 that contain the word q in the surrounding texts.

The processor which performs the method consists of several machine learning modules. The first module of this framework is a module 13 for automatic web image retrieval. The module 13 receives from the user a query in the form of at least one textual term (step 1 of the method of FIG. 1). In the following description it is assumed that there is only a single textual term defining a single concept, but the method can be generalized straightforwardly to the case of multiple textual terms. The module 13 uses the textual term to extract relevant images from the database 12 (step 2). For any textual term q, the module 13 efficiently retrieves all web images whose surrounding texts contain the word q by using the pre-constructed inverted file. These web images are deemed to be relevant images.

In step 3 of the method, the module 13 uses the function WordNet (a lexical database of the English language maintained by Princeton University, and accessible at the website www.wordnet.princeton.edu) to interpret [11, 22] the semantic concept of the textual term(s). As illustrated in FIG. 3, WordNet generates a set C_{S} of “descendant” texts of q, based on a specified number of levels in the database. In the example of FIG. 3, q is “boat”, the first-level descendants are “ark” and “barge”. “Barge” has two second-level descendants: “dredger” and “houseboat”.

In step 4, the method retrieves all images in the second database 12 that do not contain any of the words C_{S} in their surrounding texts. These are designated ‘irrelevant” web images.

The relevant and irrelevant web images are denoted by

$${D}^{w} = ( {x}_{i}^{w} , {y}_{i}^{w} ) {\vert}_{i = 1}^{{n}_{w}}$$

where n_{w} is the total number of images in the second database 12, xᵢ^{w} is the i-th web image, and yᵢ^{w}ε{±1} according to whether the i-th image is relevant (yᵢ^{w}=1) or irrelevant (yᵢ^{w}=−1).

In step 5, a second module 14 of the system uses these annotated web images as the training set for building a first multimedia file classifier engine (here called simply a classifier). In step 6, the classifier is used for classifying images in the first database 11 (the target photos).

Any classifiers (such as a k-Nearest-Neighbor classifier, a Decision Stump classifier, a support vector machine (SVM) or a boosting classifier) can be used in step 5. However, since the number of web images in D^{w} can be up to millions, direct training of complex classifiers (such as non-linear SVMs or boosting classifiers) may not be suitable for real-time target photo retrieval. The module 14 of FIG. 2 therefore typically uses simple but effective classifiers, such a k-Nearest-Neighbor classifiers, Decision Stump Ensembles or linear SVMs.

Let us first take the case that step 5 constructs a k-Nearest-Neighbors classifier. In step 6, the classifier of the module 14 computes, for each of the target photos in the database 11, the average distance between that target photo and its k nearest neighbors (kNN) among the relevant web images in D^{w}. For example, k may be taken as 300. Then, the classifier generated by the module 14 ranks all target photos with respect to the average distances to their k nearest neighbors.

Note that the kNN approach does not employ the irrelevant photos for target photo retrieval. To improve the retrieval performance, we can instead in step 5 construct a Decision Stump Ensemble classifier. However, the number of the irrelevant images (which is typically in the millions) in D^{w} may be much larger than the number of relevant images, so the class distribution in D^{w} can be very unbalanced. Accordingly, following the method proposed in [20], the classifier generated by the module 14 randomly selects a specified number of irrelevant web images (denoted here as the “negative” samples), and combines these with the relevant web images (the “positive” samples) to construct a smaller training set. The smaller training set is used to train a decision stump classifier.

The decision stump classifier employs an ensemble of decision stumps, indexed by d. Each decision stump relates to a d-th feature in one of the images, and uses a respective function ƒ_{d}(x)=h(s_{d}(x_{d}−θ_{d})), where θ_{d} is a real number which acts as a threshold, x_{d} denotes the magnitude of the d-th feature within an image x, and s_{d}ε{±1}. h(x) may be a sign function (i.e. h(x)=1 if x>0, and h(x)=−1 otherwise), in which case the decision stump gives a discrete output. Alternatively, h(x) may be selected as the symmetric sigmoid activation function h(x)=(1−exp(−x))/(1+exp(−x)), so that the decision stump has a continuous output. This is the selection which is used in the rest of this document. For each d, the values θ_{d} and s_{d} are chosen so as to separate the positive and negative samples with a minimum training error ε_{d}. θ_{d} can be determined by sorting all the samples according to the d-th feature, and scanning the sorted feature values.

Next, a weighted sum of the decision stumps is calculated:

$$\tilde{f} ( x ) = {\sum }_{d} {γ}_{d} h ( {s}_{d} ( {x}_{d} - {θ}_{d} ) ) \qquad ( 1 )$$

The corresponding weight γ_{d} for each stump is set to be proportional to 0.5−ε_{d}, where ε_{d} is the training error rate of the d-th decision stump. γ_{d} is further normalized such that

$${\sum }_{d} {γ}_{d} = 1.$$

To remove the possible side effect of random sampling of the irrelevant images, the whole procedure is repeated nₛ times, such as nₛ=100 times, using different randomly sampled irrelevant web images each time, to produce a source classifier ƒ^{s} which is the average over the nₛ sets of negative results. Note that the average value is not just ±1, but is instead a value which can take any of a large number of values for different images x in the second database 11, so that a ranking of those images is possible based on the corresponding average value. This sampling strategy is known as Asymmetric Bagging [20].

After asymmetric bagging with decision stumps, the first multimedia file classifier engine includes nₛn_{d} decision stump classifiers, where n_{d} is the feature dimension (i.e. the number of features). We may improve the first multimedia file classifier engine by removing a certain proportion (e.g. 20%) of the decision stumps with the largest training error rates. This removal process generally preserves the most discriminant decision stumps, and at the same time accelerates the initial photo retrieval process.

While the decision stump ensemble classifier can effectively exploit both relevant and irrelevant web photos in D^{w}, this classifier is not optimally efficient for a large consumer photo dataset in database 11 because all the decision stumps need to be applied on every test photo in step 6 (explained below). Suppose we train nₛn_{d} decision stump classifiers, where n_{d} is the feature dimension (i.e. the number of features). Then, for each test image, all the decision stumps need to be applied in step 6, which means that even if 20% of the decision stump classifiers with the largest training rate errors are removed, the floating value comparison and the calculation of exponential function in the symmetric sigmoid activation function will be performed 0.8nₛn_{d} times. Moreover, one decision stump classifier only accounts for one single dimension of the whole feature space. Thus, each individual classifier may have very little effect on the final result.

To facilitate large scale consumer photo retrieval, yet a further possible implementation of step 5, is asymmetric bagging with a linear SVM. The linear SVM classifier is based on loosely labeled web images. Once again, we also construct a number of smaller training sets, each of which combines the positive web images with a corresponding randomly-sampled set of the negative web images. As suggested in [13] feature vectors are normalized into unit hyper-spheres in the kernel space. For linear SVM, normalization in kernel space is equivalent to normalization in input space. For each of the sets of negative web images, which are labeled by respective values of the integer variable m, the embodiment uses a respective decision classifier in the form of a linear function ƒ_{SVM}(x)=w′ₘx+bₘ, where x is a presentation of the image in the feature space (i.e. it has n_{d} components, each equal to the amount of a corresponding d-th feature in image), so that the linear SVM classifier operates in feature space too, though it does not, like the decision stump classifier, handle each feature dimension independently. The linear SVM classifier is trained by minimizing the following objective functional:

$$\frac{1}{2} {‖ {w}_{m} ‖}^{2} + {C}_{SVM} {\sum }_{i} {ξ}_{i} such that {y}_{i}^{w} ( {w}_{m}^{′} {x}_{i}^{w} + {b}_{m} ) \geq 1 - {ξ}_{i}^{m} \qquad ( 2 )$$

where {ξᵢ^{m}} are a set of slack variables and C_{SVM} is a tradeoff parameter. The minimization is over the variables wₘ, bₘ, and {ξᵢ^{m}}. C_{SVM}, is a predefined parameter, which for example takes the default value 1 in the LibLinear toolbox [10].

We also repeat the whole procedure nₛ times, each time using a different randomly selected set of irrelevant web images. We then construct the weighted average

$${f}^{s} ( x ) = {\sum }_{m} {γ}_{m} h ( {w}_{m}^{′} x + {b}_{m} ) \qquad ( 3 )$$

where γₘ∝0.5−εₛ, and εₛ is the training error rate of the s-th linear SVM classifier, and h(x) is the symmetric sigmoid activation function defined above. γₘ is normalized such that

$${\sum }_{m} {γ}_{m} = 1.$$

Let us now compare the last two ways of implementing step 5 (i.e. using the ensemble of nₛn_{d} decision stumps, or using the linear SVM of Eqn. (3)). For the same value of nₛ, it takes more time to train the linear SVM classifier than a decision stump ensemble classifier. However, the implementation of step 6 below is much faster with linear SVM, since for item in database 11, the calculation of the exponential function in (3) only has to be performed nₛ times and it is unnecessary to perform a floating value comparison. Moreover, in the experiments described below, we observe that the linear SVM usually achieves comparable or even better retrieval performances, possibly because it simultaneously considers multiple feature dimensions. Therefore, linear SVM may be preferred for large-scale consumer photo retrieval.

The result of step 6 of the method is that the images of the first database 1 are classified based on the textual term. Optionally, the method might stop there.

However, the user also has the option of improving the classification. If he takes this option in step 7, then in step 8 the user provides data annotating certain images in the first database 11 to indicate whether they are relevant to the textual term. This is called Relevance Feedback (RF). Then in step 9, a module 15 generates an updated classifier engine, and step 6 is then repeated. This loop may be performed as often as desired, until the user decides in step 7 that no further refinement is needed.

Note that module 15 may use both the labeled web images created in steps 2 and 4, and the labeled target photos created in step 8. We denote the dataset which is the labeled target photos by

$${D}_{l}^{T} = ( {x}_{j}^{T} , {y}_{j}^{T} ) {\vert}_{j = 1}^{{n}_{l}} ,$$

where nₗ is the number of labeled target photos, which are indexed by index j. The unlabeled web images together constitute a dataset

$${D}_{u}^{T} = ( {x}_{i}^{T} , {y}_{i}^{T} ) {\vert}_{j = {n}_{l} + 1}^{{n}_{l} + {n}_{u}} ,$$

where nᵤ is the number of unlabeled images. We denote the total dataset from the source domain (i.e. database 12) by D^{w}, and we denote the total dataset from the target domain by D^{T}=Dₗ^{T}∪Dᵤ^{T} with n_{T}=nₗ+nᵤ being the total number of images in the target domain.

Note that the feature distributions of photos from the two different domains (web images and target photos respectively) may differ tremendously and thus have very different statistical properties in terms of mean, intra-class and inter-class variance. To utilize all training data from both target photos (target domain) and web images (source domain) for image retrieval, one can apply known cross-domain learning methods [32, 33, 6, 4, 15, 7, 8], which we summarize in the rest of this paragraph. Yang et al. [33] proposed a classifier called an “Adaptive Support Vector Machine” (A-SVM). The A-SVM classifier ƒ^{T}(X) is adapted from an existing auxiliary SVM classier ƒ^{s}(x) trained with the data from the source domain. Specifically, the new decision function is formulated as:

ƒ^{T}(x)=ƒ^{s}(x)+Δƒ(x) (4)

where the perturbation function Δƒ(x) is learned using the labeled data Dₗ^{T} from the target domain. As shown in [33], the perturbation function can be learned by solving a quadratic programming (QP) problem which is similar to that used to produce an SVM. Besides A-SVM, many existing works on cross-domain learning attempted to learn a new representation that can bridge the source domain and the target domain. Jiang et al. [15] proposed a classifier called a “cross-domain SVM” (CD-SVM), which uses k-nearest neighbors from the target domain to define a weight for each of the web images in the database, and then the SVM classifier is trained with re-weighted samples. Dauné III [6] proposed the “Feature Augmentation method” to augment features for domain adaptation. The augmented features are used to construct a kernel function for kernel methods. Note that most cross-domain learning methods [32, 33, 6, 15] do not consider the use of unlabeled data in the target domain. Recently, Duan et al. proposed a cross-domain kernel-learning method, referred to as a “Domain Transfer SVM” (DTSVM) [7], and a multiple-source domain adaptation method, referred to as a “Domain Adaptation Machine” (DAM) [8]. However, these methods are either variants of SVM, or are used in tandem with SVM or other kernel methods. Therefore, these methods may not be efficient enough for large-scale retrieval applications.

Reverting back to the description of the embodiment, a brute-force technique to improve photo retrieval performance would be to combine the web images and the annotated target photos in step 9 to retrain a new classifier. However, since the feature distributions of photos from different domains are drastically different, such classifiers may perform poorly. Moreover, it is also inefficient to re-train the classifier using the data from both domains.

To significantly reduce the training time, the classifier ƒ^{s}(x) (i.e. the decision stump ensemble classifier given by Eqn. (1), or the linear SVM classifier given by Eqn. (3)) generated in step 5 can be reused as the “auxiliary classifier” for relevance feedback. In a first possibility, step 9 uses a simple cross-domain learning method, referred to here as CDCC or DS_S+SVM_T. This method simply combines the weighted ensembles of the decision stumps learned in step 5 from the labeled data in the source domain D^{w} (referred to as DS_S), and a SVM classifier learned from the much smaller amount of labeled data in the target domain Dₗ^{T} (a non-linear SVM with an RBF (radial basis function) kernel, referred to as SVM_T). Specifically, the output of SVM_T is also converted into the range [−1, 1] by using the symmetric sigmoid activation function, and then the outputs of DS_S and SVM_T are combined with equal weights.

As an alternative to DS_S+SVM_T, step 9 may use a technique referred to here as “Cross-Domain Regularized Regression” (CDRR). In the sequel, the transpose of a vector or matrix is denoted by the superscript ′. For the j-th sample xⱼ, we use ƒⱼ^{T} to denote ƒ^{T}(xⱼ), and use ƒⱼ^{s} to denote ƒ^{s}(x) where ƒ^{T}(x) is the target classifier produced in step 9, and ƒ^{s}(x) is the pre-learnt auxiliary classifier. Let us define ƒₗ^{T} as [ƒ₁^{T}, . . . ƒₙ_{ₗ}^{T}]′, and define yₗ^{T} as [y₁^{T}, . . . tₙ_{ₗ}^{T}]′. Then we can write the empirical risk as functional of the target decision function on the labeled data in the target domain as:

$$\frac{1}{2 {n}_{l}} {\sum }_{j = 1}^{{n}_{l}} {( {f}_{j}^{T} - {y}_{j}^{T} )}^{2} = \frac{1}{2 {n}_{l}} {‖ {f}_{l}^{T} - {y}_{l}^{T} ‖}^{2} \qquad ( 5 )$$

For the unlabeled target patterns D_{y}^{T} in the target domain, let us define the decision values from the target classifier and the auxiliary classifier as fᵤ^{T}=[ƒₙ_{ₗ}₊₁^{T}, . . . ƒₙ_{_{T}}^{T}]′ and fᵤ^{s}=[ƒₙ_{ₗ}₊₁^{s}, . . . , ƒₙ_{_{T}}^{s}]′ respectively. We further assume that the target classifier ƒ^{T}(x) should have similar decision values to the pre-computed auxiliary classifier ƒ^{s}(x) [8]. The module 15 uses a regularization term to enforce that the label predictions of the target decision function ƒ^{T}(x) on the unlabeled data Dᵤ^{T} in the target domain should be similar to the label predictions by the auxiliary classifier ƒ^{s}(x). That is,

$$\frac{1}{2 {n}_{u}} {\sum }_{j = {n}_{l} + 1}^{{n}_{T}} {( {f}_{j}^{T} - {f}_{j}^{s} )}^{2} = \frac{1}{2 {n}_{u}} {‖ {f}_{u}^{T} - {f}_{u}^{s} ‖}^{2} \qquad ( 6 )$$

The module 15 simultaneously minimizes the empirical risk of labeled patterns in (3) and the penalty term in (4). It does this by minimizing:

$$Ω ( {f}^{T} ) + C ( \frac{λ}{2 {n}_{l}} {‖ {f}_{l}^{T} - {y}_{l}^{T} ‖}^{2} + \frac{1}{2 {n}_{u}} {‖ {f}_{u}^{T} - {f}_{u}^{s} ‖}^{2} ) , \qquad ( 7 )$$

with respect a set of tunable weight parameters which define the function ƒ^{T}(x). Here Ω(ƒ^{T}) denotes a function of the weight parameters which acts as a regularizer to control the complexity of the target classifier ƒ^{T}(X). The second term is the prediction error of the target classifier ƒ^{T}(x) on the target labeled patterns Dₗ^{T}, and the last term controls the agreement between the target classifier and the auxiliary classifier on the unlabeled samples in Dᵤ^{T}, and C>0 and λ>0 are the tradeoff parameters for the above three terms.

In one example, the module 15 uses a target decision function which is a linear regression function, i.e. ƒ^{T}(x)=w′x which is a function of a set of weight parameters w. The regularizer function Ω(ƒ^{T}) is given by ½∥w∥². The structural risk functional (5) can be solved efficiently by a linear system, by solving the equation:

$$( I + \frac{C λ}{{n}_{l}} {X}_{l} {X}_{l}^{′} + \frac{C}{{n}_{u}} {X}_{u} {X}_{u}^{′} ) w = \frac{C λ}{{n}_{l}} {X}_{l} {y}_{l}^{T} + \frac{C}{{n}_{u}} {X}_{u} {f}_{u}^{s} , \qquad ( 8 )$$

where Xₗ≡└x₁^{T}, . . . xₙ_{ₗ}^{T}┘ and Xᵤ=[xₙ_{ₗ}₊₁^{T}, . . . xₙ_{_{T}}^{T}] are data matrices of labeled and unlabeled target photos respectively, and I is the identify matrix. This has the closed-form solution:

$$w = {( I + \frac{C λ}{{n}_{l}} {X}_{l} {X}_{l}^{′} + \frac{C}{{n}_{u}} {X}_{u} {X}_{u}^{′} )}^{- 1} ( \frac{C λ}{{n}_{l}} {X}_{l} {y}_{l}^{T} + \frac{C}{{n}_{u}} {X}_{u} {f}_{u}^{s} ) \qquad ( 9 )$$

A further alternative to the DS_S+SVM_T and CDRR techniques discussed above is that in step 9 the module 15 performs a hybrid method to take the advantages of both DS_S+SVM_T and CDRR. After the user marks the target photos in step 8, the module 7 measures the average distanced d̅ between the labeled positive images and their ρ nearest neighbor target photos (ρ is set as 30 in the numerical experiments explained below). We have observed that when d̅ is larger than a threshold ε, DS_S+SVM_T is generally better than CDRR; otherwise, CDRR generally outperforms DS_S+SVM_T. The module 15 therefore uses a Hybrid approach to perform step 9 as illustrated in FIG. 4. In sub-step 9a, the module 15 calculates ρ, in sub-step 9b the module 15 determines if ρ is above or below ε, and accordingly it performs relevance feedback to construct the target classifier either using DS_S+SVM_T (sub-step 9c) or CDRR (sub-step 9d).

A yet further alternative is to perform a form of CDRR which employs an incremental updating of the weights each time the feedback loop (i.e. steps 7 to 9) is performed. This possibility is referred to here as ICDRR. In our ICDRR, we incrementally update the two matrices A₁=XₗX′ₗ and A₂=XᵤX′ᵤ, and two vectors b₁=Xₗyₗ^{T} and b₂=Xᵤfᵤ^{T} in Eqn. (9). Let us number the rounds of relevance feedback by the integer variable r, where r=0 corresponds to the situation before relevance feedback. The realizations of A₁, A₂, b₁ and b₂ in the r-th round of relevance feedback are denoted by A₁^{(r)}, A₂^{(r)}, b₁^{(r)} and b₂⁽²⁾ respectively. Before relevance feedback we initialize A₁⁽⁰⁾=0, A₂⁽⁰⁾=XX′, b₁⁽⁰⁾=0 and b₂⁽⁰⁾=Xf^{s}, where X is the data matrix of all consumer photos in the database 11. f^{s} is the output of the first multimedia file classifier on all consumer photos. In the r-th round of relevance feedback, we then incrementally update A₁, A₂, b₁ and b₂ by:

A₁^{(r)}=A₁^{(r-1)}+(ΔX)(ΔX)′ (10)

A₂^{(r)}=A₂^{(r-1)}−(ΔX)(ΔX)′ (11)

b₁^{(r)}=b₁^{(r-1)}+(ΔX)(Δy) (12)

b₂^{(r)}=b₂^{(r-1)}−(ΔX)(Δf^{s}). (13)

These equations give exactly the same results as CDRR, not just a very good approximation. In the above equations, ΔXεRⁿ^{_{d}}^{×n}^{_{c}}, ΔyεRⁿ^{_{c}} and Δf^{s}εRⁿ^{_{c}} are the data matrix, label vector, and the response vector from first multimedia file classifier from the current round, of the newly labeled consumer photos in the current round, where n_{c} is the number of user-labeled consumer photos in this round, and n_{d} is the feature dimension.

The total complexity to directly calculate A₁ and A₂ in CDRR is O(n_{d}²n_{T}), while the total complexity to incrementally update A₁ and A₂ in ICDRR is only O(n_{d}²n_{c}). Similarly, the total complexity to directly calculate b₁ and b₂ in CDRR is O(n_{d}n_{T}), while the total complexity to incrementally update b₁ and b₂ in ICDRR is only O(n_{d}n_{c}). The user only labels a very limited number of consumer photos in each round of relevance feedback (i.e. n_{c} is much smaller than n_{T}), so the computational cost for updating A₁^{(r)}, A₂^{(r)}, b₁^{(r)} and b₂⁽²⁾ becomes negligible in ICDRR. Moreover, A₂⁽⁰⁾=XX′can be computed offline because it does not depend on the first multimedia file classifier, and b₂⁽⁰⁾=Xf^{s} can be computed when the user inspects the initial retrieval result (it costs less than 0.15 seconds with one single CPU thread even on the NUS-WIDE dataset described below with about 270K images). Therefore in our experiments, we do not count the time for calculating A₂⁽⁰⁾=XX′ and b₂⁽⁰⁾=Xf^{s}. The experimental results show that ICDRR significantly accelerates the relevance feedback process for large scale photo retrieval.

### 2. Experimental Results

### 2.1 Setting Up the Databases 11 and 12 of the Embodiment

We have evaluated the performance of the embodiment for textual query based target photo retrieval. First, we compared the retrieval performances using in step 5 either the kNN classier based method, the decision stump classier based method, and linear SVM classifier without using relevance feedback. Second, we evaluated the effect of relevance feedback using methods DS_S+SVM_T and CDRR.

The second database 12 was formed using about 1.3 million photos from the photo forum Photosig as the training dataset. Most of the images are accompanied by rich surrounding textual descriptions (e.g., title, category and description). After removing the high-frequency words that are not meaningful (e.g., “the”, “photo”, “picture”), our dictionary contains 21,377 words, and each image is associated with about five words on the average. Similarly to [29], we also observed that the images in Photosig generally are high resolution with the sizes varying from 300×200 to 800×600 pixels. In addition, the surrounding descriptions more or less describe the semantics of the corresponding images.

We tested the performance of the embodiment using two successive databases as the first database 11. The first test dataset (“the Kodak dataset) was derived from the Kodak Consumer Video Benchmark Dataset [17], which was collected by Eastman Kodak Company from about 100 real users over the period of one year. In this dataset, 5,166 key-frames (the image sizes vary from 320×240 to 640×480 pixels) were extracted from 1,358 consumer video clips. Key-frame based annotation was performed by the students at Columbia University to assign binary labels (presence or absence) for each visual concept. To the best of our knowledge, this dataset is the largest annotated dataset from personal collections. Note that this annotation data was only used in this experiment to evaluate the performance of the embodiment; it was not used by the embodiment to retrieve photos from the Kodak database. Twenty-five semantic concepts were defined, including 22 visual concepts and three audio-related concepts (i.e. “singing”, “music” and “cheer”). We also combined two concepts “group of two” and “group of three or more” into a single concept (“people”) for the convenience of searching for relevant and irrelevant images from the Photosig web image dataset. Observing that the keyframes from the same video clip are generally near duplicate images, we select only the first keyframe from each video clip in order to fairly compare different algorithms. In total, we tested our framework on 21 visual concepts and with 1,358 images.

The second test dataset was the Corel stock photo dataset [27]. We recognized that Corel is not a target photo collection, but decided to include it nevertheless because it was used in other studies and also represents a cross-domain case. We use the same subset as in [9], in which 4,999 images (the image sizes are 192×128 or 128×192 pixels) are manually annotated in terms of over 370 concepts. Since many concepts have very few images, we only chose 43 concepts that contain at least 100 images.

The third test database was the NUS-WIDE database [5], which was collected by the National University of Singapore (NUS). In total, this dataset has 269,648 images and ground-truth annotations for 81 concepts. The images in the NUS-WIDE dataset are downloaded from the online consumer photo sharing website Flickr.com. We choose NUS-WIDE dataset because it is the largest annotated consumer photo dataset available to researchers today, and is suitable for testing the performances of our framework for large-scale photo retrieval. Moreover, it is also meaningful to use this dataset to test the retrieval precisions of our cross-domain relevance feedback methods CDCC and CDRR because the data distributions of photos downloaded from different websites, i.e. Photosig.com and Flickr.com are still different. It is also worth noting that the images in NUS-WIDE are used as raw photos, in other words, we do not consider the associated tag information in this work.

In our experiments, we used three types of global features. For Grid Color Moment (GCM), we extracted the first three moments of three channels in the LAB color space from each of the 5×5 fixed grid partitions, and aggregated the features into a single 225-dimensional feature vector. The Edge Direction Histogram (EDH) feature includes 73 dimensions with 72 bins corresponding to edge directions quantized in five angular bins and one bin for non-edge pixels. Similarly to [5], we also extracted 128-dimensional Wavelet Texture (WT) features by performing a Pyramid-structured Wavelet Transform (PWT) and a Tree-structured Wavelet Transform (TWT). Finally, each image was represented as a single 426-dimensional vector by concatenating three types of global features. Refer to [5] for more details about the features. We use the above global features because they can be efficiently extracted over the large image corpus and they have been shown to be effective for consumer photo annotation in [5].

For the training dataset photosig, we calculated the original mean value μ_{d} and standard deviation σ_{d} for each dimension d, and also normalized all dimensions to zero mean and unit variance. We also normalized the three test datasets (i.e. the Kodak, Corel and NUS-Wide databases) by using μ_{d} and σ_{d}.

The experiments are performed on a server machine with dual Intel Xeon 3.0 GHz Quad-Core CPUs (eight threads) and 16 GB Memory. Our system is implemented in C++. Matrix and vector operations are performed using the Intel Math Kernel Library 10.0.

### 2.2. Experimental Results Using the Kodak and Corel Databases

We now describe a first set of experiments performed using the Kodak and Corel databases.

To improve the speed and reduce the memory cost, we first performed Principal Component Analysis (PCA) using all the images in the photosig dataset. We observed that the first n_{d}=103 principal components are sufficient to preserve 90% energy. Therefore, all the images in the training and test datasets were projected into the 103-dimensional space after dimension reduction.

2.2.1 Retrieval without Relevance Feedback

Considering that the queries in known CBIR methods and our framework are different in nature, we cannot compare our work with the existing CBIR methods before relevance feedback. We also cannot compare the retrieval performance of our framework with web-based annotation methods, because of the following two aspects: 1) The prior works [16, 22, 23, 25, 28, 29] only output binary decisions (presence or absence) without providing a metric to rank the personal photos; 2) An initial textual term is required before image annotation in [14, 28, 29] and their annotation performances depend heavily on the correct textual term, making it difficult to fairly compare their methods with our automatic technique. However, we notice that the previous web-based image annotation methods [16, 22, 23, 25, 28, 29] all used a kNN classifier for image annotation, possibly owing to its simplicity and effectiveness. Therefore, we directly compared the retrieval performance of decision stumps and the base-line kNN classifier.

Suppose a user wants to use the textual query q to retrieve the relevant personal images. For both methods, we randomly select nₚ positive images (that is, images for which the surrounding textual descriptions contains term q) from the Photosig dataset where nₚ is the lesser of 10000 and n_{q}, where n_{q} is the total number of images that contain the word q in the surrounding textual descriptions. The Kodak and Corel datasets contain 61 distinct concepts in total (the concepts “beach”, “boat” and “people” appear in both datasets). The average number of selected positive samples of all the 61 concepts is 3703.5. In the case that the embodiment uses decision stumps, we also randomly choose nₚ negative samples (that is, images for which the surrounding textual descriptions do not contain the term q). This was done nₛ times, each time using a different set of nₚ negative samples. nₛ was set to 100 in the experiment. Thus, in total the embodiment trained nₛ×n_{d}=10300 decision stumps. As mentioned above, the 20% of the decision stumps which have the largest training error rates are removed before computing the weighted ensemble output.

There are 21 concept names from Kodak dataset and 43 concept names of Corel dataset, respectively. They are used as textual queries to perform image retrieval. A parameter called “precision” is defined as the percentage of relevant images in the top I retrieved images, where I is an integer. The precision parameter is used as the performance measure to evaluate the retrieval performance. Since online users are usually interested in the top ranked images only, the experiments used 20, 30, 40, 50, 60 and 70 as the value of I, similarly to [20]. For any query q, we rank the consumer photos in Kodak and Corel databases using the embodiment. We then compare the ranked results and ground-truth labels obtained by manual annotation to calculate the precision. Decision stumps based on the training data from the source domain (referred to as DS_S) generally outperform kNN. This is possibly because DS_S employs both positive and negative samples to train the robust classifier while kNN only utilizes the positive samples.

A first experiment was performed in which the textual term q used as a query was “pool”. Note that this query is not in the concept lexicon of the Kodak dataset.

2.2.2 Retrieval with Relevance Feedback (RF)

In this subsection, we evaluate the performance of the embodiment when incorporating the feedback steps 7-9. For fair comparison, the embodiment used DS_S to obtain the initial retrieval results for all the methods except for the baseline kNN based RF method kNN_RF and A-SVM [33], which use kNN and SVM for initial retrieval respectively. For CDRR, the value of C was empirically chosen to be 20.0. A was set to 0.02 for the first feedback round, and to 0.04 for the remaining rounds.

It was observed that CDRR generally achieves better performance if we respectively set yⱼ^{T}=1 for positive images, and yⱼ^{T}=−0.1 for negative images, rather than setting yⱼ^{T}=1 for positive images and yⱼ^{T}=−1 for negative images as described above. It is better to set yⱼ^{T}=−0.1 for the negative images because, whereas the positive images marked by the user are mainly top-ranked images, the negative images marked by the user in the relevance feed-back are typically not extremely negative images. In our Hybrid method, we empirically fixed ρ to be 30, and set ε to be 14.0 and 10.8 for Kodak and Corel datasets respectively.

We compared the DS_S+SVM_T classifier, the CDRR classifier and the Hybrid method with the following methods:

1) kNN_RF: The initial retrieval results are obtained by using kNN. In each feedback round, kNN is performed again on the enlarged training set, which includes the labeled positive feedback images marked by the user in the current and all previous rounds, as well as the original nₚ positive samples from the photosig dataset obtained before relevance feedback. The rank of each test image is determined based on the average distance to the top-300 nearest neighbors from the enlarged training set.
2) SVM_T: A SVM has been used for RF in several existing CBIR methods [20, 21, 34]. We trained a SVM based on the labeled images in the target domain, which are marked by the user in the current and all previous rounds. We set C=1 and γ in the RBF kernel to be 1/103.
3) A-SVM: Adaptive SVM (A-SVM) is a recently proposed method [33] for cross-domain learning as described above. A SVM based on RBF kernel is used to obtain the initial retrieval results. The parameter setting is the same as that in SVM_T.
4) MR: Manifold Ranking (MR) is a semi-supervised RF method proposed in [12]. The parameters α and γ for this method are set according to [12].

In real circumstances, the users typically would be reluctant to perform many rounds of relevance feedback or annotate many images for each round. Therefore, we only report the results from the first four rounds of feedback. In each feedback round, the user marks one or more relevant images (these can be any of the images, but typically user prefer to mark the highest ranked images) out of the top 40 images as a positive feedback sample. Similarly, one or more negative samples out of the top 40 images are marked.

In further numerical experiments it was found that:

1) When the embodiment uses the CDRR and DS_S+SVM_T methods for RF, it outperforms the RF methods kNN_RF, SVM_T and MR as well as the existing cross-domain learning method A-SVM in most cases, because they successfully utilize the images from both domains. By taking the advantages of DS_S+SVM_T and CDRR, the hybrid method generally achieves the best results. When comparing the Hybrid approach with SVM_T after the first round of relevance feedback, the relative improvements are no less than 18.2% and 19.2% on the Corel and Kodak datasets, respectively. Moreover, the retrieval performance of our CDRR, DS_S+SVM_T and the Hybrid method increase monotonically with more labeled images provided by the user in most cases. For CDRR, we believe that the retrieval performance can be further improved by using a non-linear function in CDRR. However, it is a non-trivial task to achieve the real-time retrieval performance with RBF kernel function.
2) The retrieval performances of kNN_RF are almost the same, even after 4 rounds of feedback, possibly because the limited number of user-labeled images in the target domain cannot influence the average distance from the nearest neighbors, and because of the kNN method's inability to utilize negative feedbacks;
3) For SVM_T, the retrieval performances sometimes drop after the first round of RF, but increase from the second iteration. The explanation is that since SVM_T is trained using a limited number of labeled training images, it is not reliable, but its performance can improve when more labeled images are marked by the user in the subsequent feedback iterations.
4) The performance of A-SVM is slightly improved after using RF in most cases. It seems that the limited number of labeled target images from the user are not sufficient to facilitate robust adaptation for A-SVM. The initial results of A-SVM were better than DSS on the Kodak dataset because of the utilization of SVM for initialization. However, it takes more than 10 minutes to train the SVM classifier, making it unsuitable for the practical image retrieval application.
5) The semi-supervised learning method MR can improve the retrieval performance only in some cases on Kodak dataset, possibly because the manifold assumption does not hold well for unconstrained consumer images.

The running times of the embodiment for the initial retrieval and RF are shown Table 1 and Table 2, respectively. In this work, each decision stump classifier can be trained and used independently. Therefore, we also use the simple but effective parallelization scheme, OpenMP, to take advantages of multiple threads. In Table 1 and 2, we do not consider the time of loading the data from the hard disk because the data can be loaded once and then used for subsequent queries. The times given in the tables are average CPU times in seconds. In table 2, the times are given for one round of RF with one single thread.

TABLE 1

| Method | |
|---|---|
| DS_S | kNN |

| # Threads | 1 | 8 | 1 | 8 |
|---|---|---|---|---|
| Time (in secs) | 8.528 | 2.042 | 3.265 | .913 |

TABLE 2

| Method | DS_S + SVM_T | CDRR | Hybrid |
|---|---|---|---|
| Time | 0.056 | 0.052 | 0.097 |
| Method | MR | SVM_T | A_SVM |
| Time | 0.051 | 0.054 | 26.179 |

As shown in Table 1, for the DS_S the average running time of the initial retrieval for all the concepts is about 8.5 seconds with a single thread and 2 seconds with 8 threads. As can be seen from Table 2, the RF process of DS_S+SVM_T and CDRR is very responsive, because module 15 only needs to train a SVM with less than 10 training samples for DS_S+SVM_T, or solve a linear system for CDRR (using Eqn. (7)). In practice, DS_S+SVM_T, CDRR and the Hybrid method all take less than 0.1 seconds per round. Therefore, our system is able to achieve real-time retrieval. All the other methods, except for A-SVM, can also achieve real-time retrieval. Similarly to [33], we train an SVM classifier based on an RBF kernel to obtain the initial retrieval result for A-SVM. While the initial retrieval performance of A-SVM is better than DS S on the Kodak dataset, it takes 610.9 s. In the relevance feedback stage, the target classifier is adapted from the initial SVM classifier. Its speed is also very slow (about 26 seconds per round), making it infeasible for interactive photo retrieval.

In conclusion, the embodiment when using the simple decision stump classifier as the source classifier achieved (quasi) real-time response. The Hybrid method in particular requires an extremely limited amount of feedback from the user and it outperforms other popular relevance feedback methods. Some efficient linear SVM implementations (e.g., LIBLINEAR) may be also used in the embodiment. In addition, non-linear functions may be also employed in CDRR to further improve the performance of the embodiment.

### 2.3. Experimental Results Using the Kodak and NUS-WIDE Databases

2.3.1 Retrieval without Relevance Feedback

In these experiments we directly compared the retrieval performance of decision stump ensemble classifier and the linear SVM classifier, using as a baseline the k-NN classifier. Again, suppose a user wants to use the textual query q to retrieve the relevant personal images. For each classifier, we randomly select nₚ positive images (that is, images for which the surrounding textual descriptions contains term q) from the Photosig dataset where nₚ is the lesser of 10000 and n_{q}, where n_{q} is the total number of images that contain the word q in the surrounding textual descriptions. The Kodak and NUS-WIDE datasets contain 94 distinct concepts in total (the concepts “animal”, “beach”, “boat”, “dancing”, “person”, “sports”, “sunset” and “wedding” appear in both datasets). The average number of selected positive samples of all the 94 concepts is 3088.3.

To improve the speed and reduce the memory cost, we perform Principal Component Analysis (PCA) using all the images in the photosig dataset. We also compare the performances of two possible fusion methods to fuse three types of global features in this application.
Early Fusion: We concatenate the three types of features before performing PCA. We observe that the first n_{d}=103 principal components are sufficient to preserve 90% of the energy. After dimension reduction, all the images in training and test datasets are projected into the 103-D space for further processing.
Late Fusion: We perform PCA on three types of features independently. We observe that the first n_{d1}=91, n_{d2}=24, n_{d3}_{_{—}}=5 principal components are sufficient to preserve 90% of the energy for GCM, EDH and WT features, respectively. Then, these three types of features of all the images in the training and test datasets are projected to n_{d1}-D, n_{d2}-D, n_{d3}-D space respectively after dimension reduction. We train independent classifiers based on each type of feature. Finally, the classifiers from different features are linearly combined with the combination weights determined based on the training error rates.

For each fusion method, we compare the following three methods:
k-NN_S: We only use the positive images from the web-image database as the training data. For each consumer photo from the testing dataset, we find the top k nearest neighbors in the positive images, and use the average distance to measure the relevance between the textual query and the testing consumer photo. In the experiment, we set k=200. We also perform an exhaustive exact k-NN search accelerated by SIMD CPU instructions and multiple threads. For the k-NN based method with late fusion, we combine the outputs of all k-NN classifiers with equal weights because the training error rate of the k-NN classifier on each type of feature is unknown in this case. In the sequel, we denote k-NN_S with early fusion and late fusion by k-NN_SE and k-NN_SL, respectively.
DS_S: We randomly choose nₚ negative samples nₛ times, and in total we trained nₛn_{d} decision stumps for early fusion (referred to as DS_SE) or nₛ(n_{d1}+n_{d2}+n_{d3}) for late fusion (referred to as DS_SL). After removing the 20% of the decision stumps with the largest training error rates, we apply 0.8nₛn_{d} or 0.8nₛ(n_{d1}+n_{d2}+n_{d3}) decision stumps for the testing stage in DS_SE and DS_SL, respectively.
LinSVM_S: We also randomly choose nₚ negative samples nₛ times. In total, we trained nₛ linear SVM classifiers for early fusion (referred to as LinSVM_SE) or 3nₛ classifiers for late fusion (referred to as LinSVM_SL). In this work, we use tools from LibLinear [10] in our implementations and use the default value 1 for the parameter C_{SVM}.

There are 21 and 81 concept names from the Kodak dataset and NUS-WIDE dataset, respectively. They are used as textual queries to perform image retrieval. Precision (defined as the percentage of relevant images in the top I retrieved images) is used as the performance measure to evaluate the retrieval performance. Since online users are usually interested in the top ranked images only, we set I as 20, 30, 40, 50, 60 and 70.

We tested all the methods above for initial retrieval without using relevance feedback. For the Kodak dataset, we set the number nₛ of sets of random samples of negative images to 50 for DS_SE and DS_SL, and 10 for LinSVM_SE and LinSVM_SL in order to make the running time of initial retrieval process under 1 second. The precisions of all methods are shown in FIG. 5. We observe that DS_SE, DS_SL, LinSVM_SE and LinSVM_SL are much better than k-NN_SE and k-NN_SL. This is possibly because k-NN_SE and k-NN_SL only utilize the positive web images while the other methods take advantage of both the positive and negative web images to train the more robust classifiers. Moreover, the average values of the top 20, 30, 40, 50, 60 and 70 precisions from LinSVM_SL, DS_SL, LinSVM_SE and DS_SE, are 14.50%, 14.47%, 14.39% and 14.21%, respectively. We concluded that the linear SVM classifier and decision stump ensemble classifier achieved comparable retrieval performances on the Kodak dataset.

To better compare the performances of different algorithms, we also tested them on the large NUS-WIDE dataset, and found precision variations of the different algorithms with respect to different values of nₛ, in which nₛ is set to 1, 3, 5, 7 and 10. We made the following observations:

1) Again, k-NN_SE and k-NN_SL achieve much worse performances, when compared with the other four algorithms. LinSVM_SL generally achieves the best results and it is slightly better than DS_SL in most cases.
2) When nₛ increases, DS_SE, DS_SL, LinSVM_SE, and LinSVM_SL improve in most cases, which is consistent with the recent work [20].
3) It is interesting to observe that LinSVM_SE is the worst among the four algorithms related to linear SVM and decision stump ensemble classifiers. We employed three types of features (color, edge and texture), and it is well known that none of them can work well for all concepts. LinSVM_SL, DS_SL and DS_SE achieve better performance, possibly because they can fuse and select different type of features or even feature dimensions based on the training error rates.
4) Except for k-NN classifier based algorithms, we also observed that the late fusion based methods are generally better than the corresponding early fusion based methods for photo retrieval on the NUS-WIDE dataset. k-NN_SL is worse than k-NN_SE. However, in k-NN_SL, all types of features are combined with equal weights, namely, feature selection is not performed in k-NN_SL.

The embodiment used the keyword “water” to retrieve images from the Kodak dataset using LinSVM_SL with 10 SVM classifiers. Note that this query is undefined in the concept lexicon of the Kodak dataset. FIG. 6 shows the top 10 images: that is, the 10 images ranked most highly. All but the 2nd and 6-th results are relevant images. These irrelevant images are highlighted in the figure.

In another experiment, the embodiment used the keyword “animal” to retrieve images from the NUS-WIDE database using LinSVM_SL with 10 SVM classifiers (“animal” is defined in the concept lexicon of NUS-WIDE). The embodiment produces six relevant images out of the top 10 retrieved images.

We also compared the running time of all algorithms on the two datasets. Each decision stump classifier and SVM classifier can be trained and used independently, and exhaustive k-NN search is also easy to parallelize. We therefore use a simple but effective parallelization scheme, OpenMP, to take advantages of eight threads of our server for each method. The average, minimum and maximum running time in the initial retrieval process on the Kodak and NUS-WIDE dataset are reported in Table 1. For DS_SE and DS_SL, nₛ=50 is used on the Kodak dataset and nₛ=10 is used on the NUS-WIDE dataset. For LinSVM_SE and LinSVM_SL, nₛ=10 is used on both datasets.

TABLE 1

| | | | | |
|---|---|---|---|---|
| Method | DS_SE | DS_SL | LinSVM_SE | LinSVM_SL |

Dataset: Kodak

| | | | | |
|---|---|---|---|---|
| Time_{Avg} | 0.912 | 0.969 | 0.830 | 0.852 |
| Time_{Min} | 0.263 | 0.277 | 0.078 | 0.078 |
| Time_{Max} | 1.695 | 1.841 | 2.209 | 2.328 |

Dataset: NUS-WIDE

| | | | | |
|---|---|---|---|---|
| Time_{Avg} | 1.373 | 1.575 | 0.782 | 0.878 |
| Time_{Min} | 1.141 | 1.344 | 0.125 | 0.235 |
| Time_{Max} | 1.812 | 2.281 | 2.640 | 2.735 |

On the average, k-NN_SE spends 0.872 seconds for the initial retrieval process on the Kodak dataset. On the average, k-NN_SL spends 1.033 seconds for the initial retrieval process on the Kodak dataset.

On the average, DS_SE and DS_SL with nₛ=50, and LinSVM_SE and LinSVM_SL with nₛ=10, spent 0.912, 0.969, 0.830, and 0.852 seconds, respectively. All methods can achieve real-time retrieval performance on this small dataset.

On the NUS-WIDE dataset, k-NN_SE and k-NN_SL spent 213.35 and 225.73 seconds, respectively. We implement a k-NN based on exhaustive search, thus it takes much more time when compared with decision stump ensemble classifier and linear SVM classifier. When nₛ is 10, LinSVM_SE, LinSVM_SL are much faster than DS_SE and DS_SL in terms of the minimum CPU time. The average total running time of LinSVM_SE, LinSVM_SL, DS_SE and DS_SL are 0.782, 0.878, 1.373 and 1.575 seconds, respectively. We also observe that LinSVM_SE and LinSVM_SL generally cost more time than DS_SE and DS_SL in the training stage. However, the testing stage of LinSVM_SE and LinSVM_SL is much faster, making the average total running time of initial retrieval process much shorter than DS_SE and DS_SL.

From the experiments on the Kodak dataset, we observe that methods based on the linear SVM classifier and the decision stump ensemble classifier are generally comparable in terms of initial retrieval precision and speed. Since all the algorithms can achieve real-time speed, any of them can be used for initial retrieval on a small dataset. However, for large-scale photo retrieval, LinSVM_SL is preferred for the initial retrieval process because of its effectiveness and real-time response.

2.3.2 Retrieval with Relevance Feedback (RF)

In this section we evaluate the performance of a few relevance feedback methods. For fair comparison, we choose LinSVM_SL with 10 SVM classifiers, which as demonstrated above was the best algorithm in terms of overall performances for retrieval before relevance feedback. LinSVM_SL is also accordingly chosen as the source classifier in our methods CDCC and CDRR. From here on, we also refer to CDCC as LinSVM_SL+SVM_T, in which the responses from LinSVM_SL and SVM_T are equally combined. In our LinSVM_SL+SVM_T, CDRR and two conventional manifold ranking and SVM based relevance feedback algorithms [12, 34], we also adopt the late fusion scheme used in LinSVM_SL to integrate the three types of global features, namely, the three types of features are used independently at first and the decisions or responses are finally fused. The early fusion approach is used for the prior cross-domain learning method A-SVM [33] because it is faster.

We compare our LinSVM_SL+SVM_T method and CDRR with the following methods:

1) SVM_T: SVM has been used for RF in several existing CBIR methods [20, 21, 34]. We train a non-linear SVM with an RBF kernel based on the labeled images in the target domain, which are marked by the user in the current and all previous rounds. We use LibSVM package [2] in our implementation and use its default setting for RBF kernel (i.e. C is set as 1 and y in the RBF kernel is set as 1/91, 1/24 and ⅕ for GCM, EDH and WT features, respectively).
2) MR: Manifold Ranking (MR) is a semi-supervised RF method proposed in [12]. The two parameters α and γ for this method are set according to [12].
3) A-SVM: Adaptive SVM (A-SVM) is a recently proposed method [33] for cross-domain learning, in which SVM based on an RBF kernel is used as the source classifier to obtain the initial retrieval results. The parameter setting is the same as that in SVM_T. Considering the running time of A-SVM is much higher than other methods even on the small Kodak dataset, we do not test it on the large NUS-WIDE dataset because it cannot achieve real time response.

As in other methods [12, 33, 34], several parameters needed to be decided beforehand. In LinSVM_SL+SVM_T, we need to determine the parameters in SVM_T and we use the same parameters setting as that in SVM_T. For CDRR, we empirically fix C=70.0 and set λ=0.05 on the Kodak dataset and λ=0.02 on the NUS-WIDE dataset. We use a smaller λ on the NUS-WIDE dataset in order to avoid over-emphasizing the labeled data in the large photo dataset. In addition, as in the experiments reported earlier, we also observe that CDRR generally achieves better performance, if we respectively set yᵢ^{T}=1 and yᵢ^{T}=−0.1 for positive and negative consumer photos, when compared with the setting yᵢ^{T}=1 and yᵢ^{T}=−1, so we set yᵢ^{T}=−0.1 for negative images.

As in the earlier experiment, we only report the results from the first four rounds of feedback. In each feedback round, the user marks the top ranked relevant image out of the top 40 images as a positive feedback sample. Similarly, one negative sample out of the top 40 images is marked.

The embodiment was then used to perform one round of relevance feedback for the query “animal” on the NUS-WIDE dataset. FIG. 7(a) shows the result of an experiment of running the embodiment without using relevance feedback, using the concept “animal”. Out of the 10 top images, four are incorrect (the 2^{nd}, 5^{th}, 7^{th} and 8^{th} images). FIG. 7(b) shows the top-10 retrieved images after one round of relevance feedback for the same query. Only the 7-th image is now incorrect.

We observe that the results are improved considerably after using the CDRR relevance feedback algorithm. From these results, we have the following observations:

1) The CDRR and LinSVM_SL+SVM_T algorithms outperform the conventional RF methods SVM_T and MR, because of the successful utilization of the images from both domains. When comparing CDRR with SVM_T and MR, the relative precision improvements after RF are more than 14.7% and 13.5% on the Kodak and NUS-WIDE datasets, respectively. CDRR is generally better than or comparable with LinSVM_SL+SVM_T, and the retrieval performances of our CDRR and LinSVM_SL+SVM_T increase monotonically with more labeled images provided by the user in most cases.
2) For SVM_T, the retrieval performance drops after the first round of RF, but increases from the second iteration. The explanation is that SVM_T trained based on two labeled training images is not reliable, but its performance can improve when more labeled images are marked by the user in the subsequent feedback iterations.
3) Semi-supervised learning method MR can improve the retrieval performance only in some cases on the Kodak dataset, possibly because the manifold assumption does not hold well for unconstrained consumer images.
4) The performance of A-SVM is slightly improved after using RF in most cases. It seems that the limited number of labeled target images from the user are not sufficient to facilitate robust adaptation for A-SVM. We also observe that initial results of A-SVM is better than other algorithms on the Kodak dataset because of the utilization of non-linear SVM for initialization. However, it takes 324.3 seconds with one thread for the initial retrieval process even on the small-scale Kodak dataset, making it unsuitable for practical image retrieval applications even with eight threads.

We now compare the running time of all relevance feedback algorithms used in our experiment. Considering that all the algorithms except A-SVM and MR on the NUS-WIDE dataset are very responsive, we test all the algorithms by using only one single thread for relevance feedback.

The comparison of time cost on the Kodak dataset is shown in Table 2. All methods except A-SVM are able to achieve the interactive speed on this small dataset. In addition, the incremental cross-domain learning method ICDRR is faster than CDRR.

TABLE 2

| Method | ICDRR | CDRR | LimSVM_SL + SVM_T | SVM_T | MR | A-SVM |
|---|---|---|---|---|---|---|
| Time_{Avg} | 0.015 | 0.032 | 0.015 | 0.015 | 0.037 | 9.921 |
| Time_{Min} | 0.014 | 0.031 | 0.015 | 0.010 | 0.026 | 0.010 |
| Time_{Max} | 0.017 | 0.034 | 0.016 | 0.016 | 0.052 | 29.532 |

In Table 3, we report the running time of different algorithms on the NUS-WIDE dataset. MR is no longer responsive in this case because the label propagation process based on the graph with much more vertices becomes much slower. The RF process of CDRR and LinSVM_SL+SVM_T (or SVM_T) is still responsive (on the average 1.534 seconds and 1.277 seconds only), because we only need to train SVM with less than 10 training samples for LinSVM_SL+SVM_T and SVM_T or solve a linear system for CDRR.

TABLE 3

| | | | LimSVM_SL + | | |
|---|---|---|---|---|---|
| Method | ICDRR | CDRR | SVM_T | SVM_T | MR |
| Time_{Avg} | 0.110 | 1.534 | 1.277 | 1.277 | 60.533 |
| Time_{Min} | 0.108 | 1.439 | 0.641 | 0.640 | 56.410 |
| Time_{Max} | 0.125 | 1.620 | 1.901 | 1.899 | 68.359 |

Moreover, ICDRR only takes about 0.1 seconds on the average per round after incrementally updating the corresponding matrices, which is much faster than CDRR. We also observe that the running time of LinSVM_SL+SVM_T (or SVM_T) increases when the number of user-labeled consumer photos increases in the subsequent iterations. Specifically, when the user labels 1, 2, 3, 4 positive consumer photos and the same number of negative photos, LinSVM_SL+SVM_T (or SVM_T) costs about 0.7, 1.1, 1.5 and 1.9 seconds on average, respectively. However, ICDRR takes about 0.1 seconds on the average in all the iterations.

In short, ICDRR can learn the same projection vector w and achieve the same retrieval precisions as CDRR, but it is much more efficient than CDRR and LinSVM_SL+SVM_T for relevance feedback in large scale photo retrieval.

### REFERENCES

The disclosure of the following citations is incorporated herein by reference:
[1] L. Cao, J. Luo, and T. S. Huang. Annotating photo collections by label propagation according to multiple similarity cues. In ACM MM, 2008.
[2] C. C. Chang and C. J. Lin, LIBSVM: a library for support vector machines, http://www.csie.ntu.edu.tw/˜cjlin/libsvm, 2001.
[3] S.-F. Chang et al. Large-scale multimodal semantic concept detection for consumer video. In ACM SIGMM Workshop on MIR, 2007.
[4] S.-F. Chang et al. Columbia University/VIREO-CityU/IRIT TRECVID2008 High-Level Feature Extraction and Interactive Video Search. In NIST TRECVID Workshop, 2008.
[5] T.-S. Chua et al. NUS-WIDE: A real-world web image database from national university of Singapore. In CIVR, 2009.
[6] H. Daume III. Frustratingly easy domain adaptation. In ACL, 2007.
[7] L. Duan et al. Domain Transfer SVM for Video Concept Detection. In CVPR, 2009.
[8] L. Duan et al. Domain Adaptation from Multiple Sources via Auxiliary Classifiers. In ICML, 2009.
[9] P. Duygulu et al. Object recognition as machine translation: Learning a lexicon for a fixed image vocabulary. In ECCV, 2002.
[10] R. E. Fan, K. W. Chang, C. J. Hsieh, X. R. Wang, and C. J. Lin, LIBLINEAR: A Library for Large Linear Classification, Journal of Machine Learning Research, p 1871-1874, 2008.
[11] C. Fellbaum. WordNet: An Electronic Lexical Database. Bradford Books, 1998.
[12] J. He et al. Manifold-ranking based image retrieval. In ACM MM, 2004.
[13] R. Herbrich and T. Graepel, A PAC-Bayesian Margin Bound for Linear Classifiers: Why SVMs work. In Neural Information Processing Systems, 2001.
[14] J. Jia, N. Yu, and X.-S. Hua. Annotating personal albums via web mining In ACM MM, 2008.
[15] W. Jiang et al. Cross-domain learning methods for high-level visual concept classification. In ICIP, 2008.
[16] X. Li et al. Image annotation by large-scale content-based image retrieval. In ACM MM, 2006.
[17] A. Loui et al. Kodak's consumer video benchmark data set: concept definition and annotation. In ACM Workshop on MIR, 2007.
[18] Y. Rui, T. S. Huang, and S. Mehrotra. Content-based image retrieval with relevance feedback in mars. In ICIP, 1997.
[19] A. Smeulders et al. Content-based image retrieval at the end of the early years. T-PAMI, 1349-1380, 2000.
[20] D. Tao et al. Asymmetric bagging and random subspace for support vector machines-based relevance feedback in image retrieval. T-PAMI, 1088-1099, 2006.
[21] S. Tong and E. Chang. Support vector machine active learning for image retrieval. In ACM MM, 2001.
[22] A. Torralba, R. Fergus, and W. T. Freeman. 80 million tiny images: a large dataset for non-parametric object and scene recognition. T-PAMI, 1958-1970, 2008.
[23] A. Torralba, R. Fergus, and Y. Weiss. Small codes and large databases for recognition. In CVPR, 2008.
[24] P. Viola and M. Jones. Robust real-time face detection. IJCV, 137-154, 2004.
[25] C. Wang et al. Content-based image annotation refinement. In CVPR, 2007.
[26] C. Wang, L. Zhang, and H. Zhang. Learning to reduce the semantic gap in web image retrieval and annotation. In SIGIR, 2008.
[27] J. Z. Wang, J. Li, and G. Wiederhold. SIMPLIcity: Semantics-sensitive integrated matching for picture libraries. T-PAMI, 947-963, 2001.
[28] X. Wang et al. AnnoSearch: Image auto-annotation by search. In CVPR, 2006.
[29] X. Wang et al. Annotating images by mining image search results. T-PAMI, 1919-1932, 2008.
[30] Y. Weiss, A. Torralba, and R. Fergus. Spectral hashing. In NIPS, 2008.
[31] I. H. Witten, A. Moffat, and T. Bell. Managing Gigabytes: Compressing and Indexing Documents and Images. Kaufmann Publishers, 1999.
[32] P. Wu and T. G. Dietterich. Improving SVM accuracy by training on auxiliary data sources. In ICML, 2004.
[33] J. Yang, R. Yan, and A. G. Hauptmann. Cross-domain video concept detection using adaptive SVMs. In ACM MM, 2007.
[34] L. Zhang, F. Lin, and B. Zhang. Support vector machine learning for image retrieval. In ICIP, 2001.

1. A method of searching a first database of multimedia files, the method comprising:
(i) receiving from a user data specifying at least one textual term;
(ii) using the textual term to search a second database of multimedia files, each multimedia file in the second database being associated with respective text, said search identifying a first set of multimedia files in the second database for which the respective text is related to the textual term and said second database being different from said first database;
(iii) constructing a first multimedia file classifier engine using the first set of multimedia files; and
(iv) searching the first database of multimedia files using the first multimedia file classifier engine, thereby identifying one or more multimedia files in the first database related to the textual term;
wherein the method further includes at least once performing the steps of:
(a) receiving from a user relevance data which specifies, for each of a second set of one or more multimedia files in the first database, an indication of whether the second set of multimedia files are respectively related to the textual term; and
(b) using the relevance data to modify the first multimedia file classifier engine to form a modified classifier engine, and repeating said step (iv) using the modified classifier engine.

2. The method of claim 1, further including a step of using the textual term to search the second database of multimedia files to identify at least one third set of multimedia files, the third set of multimedia files being multimedia files for which the respective associated text is unrelated to the textual term,
said third set of multimedia files being used in said step (iii) of constructing said first multimedia file classifier engine.

3. The method of claim 2 in which said step of using the textual term to search the second database to identify the third set of multimedia files includes the sub-steps of:
consulting a lexical database using the textual term to obtain an enlarged group of textual terms; and
searching the second database for multimedia files for which the associated text does not include any of the enlarged group of textual terms.

4. The method of claim 1 in which the second database contains indexing data which indicates, for each of a plurality of predefined textual terms, those multimedia files in the second database for which the associated text includes the corresponding one of the predefined textual terms.

5. The method of claim 1 in which the first multimedia file classifier engine is arranged, upon operating on a multimedia file, to generate a numerical relevance value indicative of the relevance of the multimedia file to the textual term, the method further including ranking at least some of the multimedia files in the first database according to the corresponding relevance values.

6. The method of claim 2, further comprising:
selecting a plurality of said third sets of multimedia files;
for each of the third sets of multimedia files, constructing a corresponding non-linear function using that third set of multimedia files and also the first set of multimedia files;
and generating the first multimedia file classifier engine as a sum of the non-linear functions.

7. The method of claim 1 in which the first multimedia file classifier engine comprises an ensemble of decision stumps, each decision stump, when applied to a certain multimedia file, generating a non-linear output indicative of the presence of a respective characteristic in that multimedia file,
the first multimedia file classifier engine combining the outputs of the decision stumps to generate a numerical value.

8. The method of claim 1 in which the first multimedia file classifier engine comprises a linear and/or non-linear function of a product of a weight vector composed of weights, and a vector representing a multimedia file input to the first multimedia file classifier engine.

9. (canceled)

10. The method of claim 5 which includes presenting to the user a plurality of multimedia files from the first database having a high ranking according to the corresponding relevance values, the relevance data relating to one or more of said plurality of multimedia files from the first database.

11. The method of claim 1 in which the first file classifier engine is modified by at least one of the following sub-steps:
(I) training an adaptive system using the relevance data and the third second set of multimedia files, the modified classifier engine generating an output by combining an output generated by the first multimedia file classifier engine with an output generated by the adaptive system; or
(II) generating a set of weight values defining the modified classifier engine, the set of weight values being generated to minimize a cost function including a term indicating disparity between the outputs of the modified classifier engine when operating on the second set of multimedia files and the corresponding relevance data.

12. The method of claim 11 in which, in sub-step (II) the cost function further includes a term indicative of the disparity between the outputs of the modified classifier engine and the corresponding outputs of the first multimedia file classifier engine when respectively operating on multimedia files in the first database which are not included in the second set of multimedia files.

13. The method of claim 11 in which the weight values are generated using a closed form expression which is a function of a set of data structures, steps (a) and (b) being performed repeatedly,
and, in each step (b), sub-step (II) comprising updating the data structures using the second set of multimedia files specified by the relevance data obtained in the preceding step (a).

14. A computer apparatus having a processor and a memory, the memory storing program instructions operative, when implemented by the processor, to cause the processor to search a first database of multimedia files, by:
(i) receiving from a user data specifying at least one textual term;
(ii) using the textual term to search a second database of multimedia files, each multimedia file in the second database being associated with respective text, said search identifying a first set of multimedia files in the second database for which the respective text is related to the textual term and said second database being different from said first database;
(iii) constructing a first multimedia file classifier engine using the first set of multimedia files;
(iv) searching the first database of multimedia files using the first multimedia file classifier engine, thereby identifying one or more multimedia files in the first database related to the textual term;
and at least once performing the steps of:
(a) receiving from a user relevance data which specifies, for each of a second set of one or more multimedia files in the first database, an indication of whether the second set of multimedia files are respectively related to the textual term; and
(b) using the relevance data to modify the first multimedia file classifier engine to form a modified classifier engine, and repeating said step (iv) using the modified classifier engine.

15. A recording medium, such as a tangible recording medium, storing program instructions operative to cause a processor performing the instructions to search a first database of multimedia files, by:
(i) receiving from a user data specifying at least one textual term;
(ii) using the textual term to search a second database of multimedia files, each multimedia file in the second database being associated with respective text, said search identifying a first set of multimedia files in the second database for which the respective text is related to the textual term and said second database being different from said first database;
(iii) constructing a first multimedia file classifier engine using the first set of multimedia files;
(iv) searching the first database of multimedia files using the first multimedia file classifier engine, thereby identifying one or more multimedia files in the first database related to the textual term;
and at least once performing the steps of:
(a) receiving from a user relevance data which specifies, for each of a second set of one or more multimedia files in the first database, an indication of whether the second set of multimedia files are respectively related to the textual term; and
(b) using the relevance data to modify the first multimedia file classifier engine to form a modified classifier engine, and repeating said step (iv) using the modified classifier engine.
